(19) United States
(12) Patent Application Publication
(10) Pub. No.: US 2006/0058428 A1
(43) Pub. Date: Mar. 16, 2006

(54) Fluorinated compounds having epoxy and vinyl ether functional groups

(75) Inventors: Haridasan K. Nair, Williamsville, NY (US); David Nalewajek, West Seneca, NY (US); Dennis M. Lavery, Springville, NY (US)

Correspondence Address: COLLEEN D. SZUCH;Honeywell International Inc., Patent Department, 101 Columbia Road, Morristown, NJ, 07962, US

(73) Assignee: Honeywell International Inc.

(21) Appl. No.: 10/942,759

(22) Filed: Sep. 16, 2004

(51) Int. Cl. C08L 63/00; C08G 59/00; B32B 27/38

(52) U.S. Cl. 523/400; 528/421

(57) ABSTRACT

Fluorinated vinyl ether-epoxides which are fluorinated compounds containing both vinyl ether and epoxide functionalities, a process for making them and their uses. The fluorinated vinyl ether-epoxide compounds have the formula 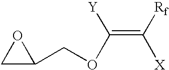
wherein X and Y are independently H, a halogen, or a linear or branched C₁ to C₁₂ fluoroalkyl group; and R_{f} is a linear or branched C₁ to C₁₂ fluoroalkyl group or a halogen.

### FIELD OF INVENTION

Present invention relates to novel fluorinated vinyl ether-epoxides. More specifically, this invention relates to fluorinated compounds containing both vinyl ether and epoxide functionalities, a process for making them and their uses.

### BACKGROUND OF THE INVENTION

Epoxides (oxiranes) are important precursors for many useful compounds of practical application such as epoxy resins which find use as coatings, inert fluids, elastomers and ionomer membranes, see Kirk-Othmer, Encylopedia of Chemical Technology, vol 9, p730-754, (1994). Non-fluorinated vinyl ethers having additional functional groups such as acrylic or epoxy are known in the art, for example, see U.S. Pat. No. 5,605,941. Such difunctional monomers are used for making many curable compositions, see U.S. Pat. No. 5,783,712.

Fluorinated oxiranes are known in the art, see for example, Huoben-Weyl-Organo-Fluorine Compounds (2000), Vol E10b/2, pages 6-18, Editors Bassner et. al, Thieme Stuttgart, New York, and U.S. Pat. No. 6,160,136 and references therein. However, it has not been known heretofore to form a fluorine containing epoxide with a substituted or unsubstituted vinyl ether functional group. Incorporation of a reactive group such as a vinyl ether group to an epoxide would make the molecule more reactive, especially in curing and cross-linking applications. Thus, there is a need to develop novel fluorinated epoxides containing vinyl ether groups. These fluorinated vinyl ether-epoxides are of particular interest in coatings applications because they form polymers and copolymers that exhibit beneficial properties, including high chemical and thermal resistance, high electrical resistivity, low surface energy and low refractive index. These properties can be imparted to a coating surface and, consequently, fluorinated vinyl ether-epoxides are particularly useful in making protective release coatings, as well as, surfactants, anticorrosion agents, antioxidizing agents and the like. Moreover, fluorinated vinyl ether-epoxides can be cured via ultraviolet (UV) radiation offer even more advantages in coatings and other applications. The photocuring process involves the radiation induced polymerization or cross linking of monomers into a three dimensional network and has a number of advantages including the environmentally safe, solvent-free 100% conversion to a desired product, as well as short cycle times and limited space and capital equipment requirements. In the telecommunications industry, for example, there is a need to develop photocurable compositions for optical wave guide and interconnect applications. In these applications, the photocurable compositions polymerize to form polymers that are highly transparent at the working wavelength and possess low intrinsic absorption and scattering loss. Accordingly, the present invention pertains to fluorinated compounds containing both epoxy and vinyl ether groups which may serve for these purposes.

### DETAILED DESCRIPTION OF THE INVENTION

The present invention provides a fluorinated vinyl ether-epoxide compound of formula 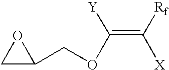
wherein X and Y are independently H, a halogen, or a linear or branched C₁ to C₁₂ fluoroalkyl group; and R_{f} is a linear or branched C₁ to C₁₂ fluoroalkyl group or a halogen.

The invention also provides a process for making a fluorinated vinyl ether-epoxide compound of the formula 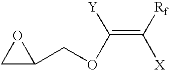
which comprises reacting a glycidol of the formula: 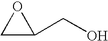
with a fluoroolefin of the formula: 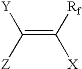
in the presence of a base and a solvent; to thereby produce a fluorinated vinyl ether-epoxide compound; wherein X, Y and Z are independently H, a halogen, or a linear or branched C₁ to C₁₂ fluoroalkyl group, provided at least one of Y and Z is a halogen;
and R_{f} is a linear or branched C₁ to C₁₂ fluoroalkyl group or a halogen.

The invention further provides a homopolymer or copolymer comprising repeating units of the formula 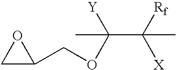
wherein X, Y and Z are independently H, a halogen, or a linear or branched C₁ to C₁₂ fluoroalkyl group, provided at least one of Y and Z is a halogen; and R_{f} is a linear or branched C₁ to C₁₂ fluoroalkyl group or a halogen.

The invention still further provides a composition comprising fluorinated vinyl ether-epoxide compound of the formula 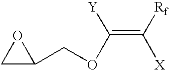
wherein X and Y are independently H, a halogen, or a linear or branched C₁ to C₁₂ fluoroalkyl group; and R_{f} is a linear or branched C₁ to C₁₂ fluoroalkyl group or a halogen; and at least one component selected from the group consisting of solvents, bases, curing agents, polymerization initiators, monomers, oligomers, polymers optionally containing at least one terminal ethylenically unsaturated group and being capable of forming a high molecular weight polymer by free radical initiated, chain propagating addition polymerization; antioxidants, photostabilizers, volume expanders, fillers, dyes, free radical scavengers, contrast enhancers and UV absorbers.

In the fluorinated vinyl ether-epoxide compounds of Formula (I), X and Y are independently H, a halogen, or a linear or branched C₁ to C₁₂ fluoroalkyl group, preferably a linear or branched C₁ to C₄ fluoroalkyl group; and R_{f} is a linear or branched C₁ to C₁₂ fluoroalkyl group, preferably a linear or branched C₁ to C₄ fluoroalkyl group or a halogen, preferably fluorine or chlorine.

Compounds of Formula (I) may be prepared according to the following reaction:

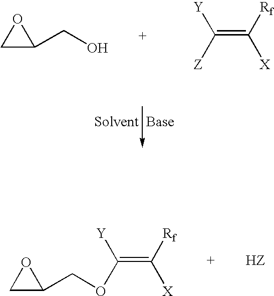

Typically, to a solution of glycidol in a solvent, preferably a polar aprotic solvent, and a base one adds a appropriate fluorolefin of the formula RfCX═CYZ; wherein X, Y and Z are independent H, halogen or a linear or branched C₁ to C₁₂ fluoroalkyl group, preferably a linear or branched C₁ to C₄ fluoroalkyl group provided that at least one of Y or Z is a halogen, in the presence of a base, for example, a weak base. The preferred halogens are fluorine and chlorine, more preferably fluorine.

Glycidol is commercially available from many vendors including Aldrich Chemical Co. The are two isomers of glycidol useful for this invention, namely the R isomer and the S isomer. The glycidol may be added to the reaction mixture in an amount of from about 0.9 equivalents to about 1.0 equivalents and preferably from about 0.95 to about 1.0 equivalents based on the amount of fluoroolefin. Generally a slight excess of fluoroolefin is employed since the unreacted fluoroolefin is generally easy to remove from the end product.

The fluoroolefins of the formula RFCX═CYZ are obtained commercially (Synquest lab, Aldrich Co or Honeywell International, Inc.) or can be obtained by art recognized procedures, see U.S. Pat. No. 6,548,719 B1. Preferred fluoroolefins are CF₃CH═CF₂ (HFC 1225), CF₃CH═CFH(HFC1234), CF₃CF═CFH(HFC-1234 yf), and CF₃CH═CFH, CF₃CBr═CF₂ and CF₃CF═CF₂, CF₃CF═CHCl, CF₃CH═CHCl (HCFC-1233), CF₃CCl═CHCl (HCFC-1223), (CF₃)₂C═CF₂, (CF₃)₂CF—CF═CF(CF₃), CF₃(CF₂)ₙCF═CF₂ wherein n=1-9, and the like. The fluoroolefin may be added to the reaction mixture in an amount of from about 1.4 equivalents to about 1.3 equivalents and preferably from about 1.2 equivalents to about 1.1 equivalents, based on the amount of fluoroolefin used. Typically the reaction may be conducted at a temperature of from about −10° C. to 120° C., preferably 10° C. to 35° C. Fluoroolefins can be either bubbled into a stirred solution of alcohol via a sparger or can be condensed via cold (dry ice) condenser. The reaction is slightly exothermic and the temperature of the reaction mixture was moderated by appropriate cooling procedure. The reaction can also be carried out in a closed container such as Fischer Porter tube or Parr^{R} reactors) under a pressure of 1-50 psi of the fluoroolefin.

Variety of bases may be used such as alkali metal hydroxides, ammonium hydroxide, alkali metal carbonates, such as sodium carbonate, potassium carbonate, alkaline metal carbonates, ammonium carbonate, and the like. Preferred bases include cesium carbonate, potassium carbonate, sodium carbonate or organic bases such as amines, for example, trialkyl amines, pyridine and the like or alkoxides such as sodium or potassium tertiarybutoxide. The amount of base is typically a catalytic amount up to one equivalent based on the amount of glycidol. Ideally one equivalent is preferred since that will neutralize the acid generated (HZ or HY). Suitable solvents include nitrites such as acetonitrile, benzonitrile; ethers such as tetrahydrofuran, diethyl ether, dibutyl ether and combinations thereof. Typically the solvent is present in an excess. By-products observed in this reaction are substitution of X and Y by glycidol when X and Z are fluorine.

All isomers of compounds of Formula I are within the scope of this invention. The products were separated and purified by conventional methods such as washing with an aqueous base, extraction, concentration, fractional distillation and the like.

The compounds of Formula I can be used for various applications including curing compositions/moldings/resins and the like, see for example, U.S. Pat. Nos. 5,783,712; 5,605,941 and 3,419,610 which are incorporated herein by reference.

The compounds of the present invention are useful in a number of applications, especially in such technology areas as optical fibers, optical instruments and equipment, electronics, coatings, laminates, and extruded or molded shapes and articles, for example, for equipment exposed to a corrosive environment such as integrated circuit fabricating equipment. Coatings derived from compounds of the present invention may be applied for example, to capacitors, resistors, and integrated circuits, for the purpose of encapsulating them to protect them from harmful environment or to provide a highly dielectric layer; to plastic sheets or metal foils for the purpose of protecting them from damage or for making laminates; to interior walls of reactors, especially those employed in highly corrosive reaction with concentrated acids or with hydrofluoric acid, to protect them from corrosion; to light-transmissive devices such as optical lenses, prisms, and glazing to impart to them improved abrasion resistance or resistance against damage in corrosive environments; to glass or quartz cores for optical fibers to form a cladding; and recording heads, disks, and tapes, and to components of radio and microwave receiving equipment such as antenna dishes, etc. to protect them from mechanical or environmental damage.

The fluorinated vinyl ether-epoxide compounds can provide a curable composition comprising at least one compound of Formula I, optionally including a curing agent. When only a compound of Formula I is present, the resulting polymer is a homopolymer. When other monomers are present, a copolymer is produced. The compositions may be curable by application of heat energy or exposure to actinic radiation. Initiator compounds may be employed. Microwave radiation may be used to apply heat to the composition. The compositions may also be catalytically cured without application of heat or exposure to actinic radiation, for example, by using an effective amount of a Lewis Acid catalyst, such as BF₃.

For purposes of the present invention, compositions that are curable by exposure to actinic radiation are defined as being “photocurable.” Suitable sources of actinic radiation include light in the visible, ultraviolet or infrared regions of the spectrum, as well electron beam, ion or neutron beam or X-ray radiation. Actinic radiation may be in the form of incoherent light or coherent light such as light from a laser.

Photocurable compositions according to the present invention preferably contain a polymerization initiator, such as a photoinitiator compound. Suitable photoinitiator compounds may be readily selected by those skilled in the art, and include, for example, Darocur 1173, Darocur 4265, Irgacure 184, Irgacure 261, Irgacure 369, Irgacure 500, Irgacure 651, Irgacure 784, Irgacure 907, Irgacure 1700, Irgacure 2959, Irgacure 1800, Irgacure 1850, Irgacure 819, And Irgacure 1300 (each commercially available from Ciba Specialty Chemicals) and GE-PI (commercially available from GE Corporation). The initiator is present in an amount sufficient to effect polymerization of the curable component. The initiator may comprise from about 0.01 to about 10% by weight, preferably from about 0.1 to about 6% by weight, and more preferably from about 0.5 to about 4% by weight of the total curable composition. Photocurable compositions contain an amount of a photoinitiator within the foregoing ranges that is sufficient to effect photopolymerization of the photocurable component upon exposure to sufficient actinic radiation.

The amount of curable component in the curable compositions may vary widely. Typically, the component is present in an amount of from about 35 to about 99% by weight of the overall composition. In a preferred embodiment, the curable component is present in an amount of from about 80 to about 99% by weight, and, more preferably, from about 95 to about 99% by weight of the overall composition. Photocurable compositions contain an amount of the curable component within the foregoing ranges that is sufficient to photocure and provide image differentiation upon exposure to sufficient actinic radiation.

In addition to the compound of Formula I, other curable compounds which are known in the art may be incorporated into the curable compositions of the present invention. These compounds include monomers, oligomers and polymers containing at least one terminal ethylenically unsaturated group and being capable of forming a high molecular weight polymer by free radical initiated, chain propagating addition polymerization. Suitable monomers include, but are not limited to, ethers, esters and partial esters of: acrylic and methacrylic acids; aromatic and aliphatic polyols containing from about 2 to about 30 carbon atoms; and cycloaliphatics polyols containing from about 5 to about 6 ring carbon atoms. Specific examples of compounds within these classes are: ethylene glycol diacrylate and dimethacrylate, diethylene glycol diacrylate and dimethacrylate, triethylene glycol diacrylate and dimethacrylate, hexane diacrylate and dimethacrylate, trimethylolpropane triacrylate and trimethacrylate, dipentaerythritol pentaacrylate, pentaarcrylate, pentaerthrytol triacrylate, pentaerythrytol tetraacrylate and trimethacrylate, alkoxylated bisphenol-A diacrylates and dimethacrylates (e.g., ethoxylated bisphenol-A diacrylate and dimethacrylate and propoxylated bisphenol-A diacrylates and dimethacrylates), alkoxylated hexafluorobiphenol-A diacrylates and dimethacrylates and mixtures of the above compounds. Preferred monomers include multifunctional aryl acrylates and methacrylates. Preferred arylacrylate monomers include di-, tri- and tetraacrylates and methacrylates based on the bis-phenol-A structure. More preferred arylacrylate monomers are alkoxylated bisphenol-A diacrylates and dimethacrylates such as ethoxylated bisphenol-A diacrylates and dimethacrylates, and ethoxylated hexafluorobisphenol-A diacrylates and dimethacrylates.

Suitable oligomers include, but are not limited to, epoxy acrylate oligomers, aliphatic and aromatic urethane acrylate oligomers, polyester acrylate oligomers, and acrylated acrylic oligomers. Epoxy acrylate oligomers (such as Ebercryl 600 by Radcure) are preferred.

Suitable polymers include, but are not limited to, acrylated polyvinyl alcohols, polyester acrylates and methacrylates, acrylated and methacrylated styrene-maleic acid co-polymers. Acrylated styrene-maleic acid copolymers are preferred.

When other ethylenically unsaturated monomers, oligomers or polymers are employed, the weight ratio of the monomer compound of Formula I to the ethylenically unsaturated compounds may vary from about 1:9 to about 9:1, and preferably from about 1:1 to about 9:1.

Various optional additives may also be added to the curable compositions of the invention depending upon the application in which they are to be used. Examples of these optional additives include antioxidants, photostabilizers, volume expanders, fillers (e.g., silica and glass spheres), dyes, free radical scavengers, contrast enhancers and UV absorbers.

Antioxidants include such compounds as phenols and particularly hindered phenols including Irganox 1010 from Ciba Specialty Chemicals; sulfides; organoboron compounds; organophosphorus compounds; and N,N′-hexamethylene-bis(3,5-di-tert-(butyl-4-hydroxyhydrocinnamamide)) available from Ciba Specialty Chemicals under the tradename Irganox 1098. Photostabilizers and more particularly hindered amine light stabilizers include, but are not limited to, poly[(6-hexamethylene)2,2,6,6-tetramethyl-4-piperidyl)imino)] available from Cytech Industries under the tradename Cyasorb UV3346. Volume expanding compounds include such materials as the spiral monomers known Bailey's monomer. Suitable dyes include methylene green and methylene blue. Suitable free radical scavengers include oxygen, hindered amine light stabilizers, hindered phenols, and 2,2,6,6-tetramethyl-1-piperidinyloxy free radical (TEMPO). Suitable contrast enhancers include other free radical scavengers. UV absorbers include benzotriazoles and hydroxybenzophenone.

The additives may be used in amounts, based on the total composition weight, of from about 0 to about 6%, and preferably from about 0.1% to about 1%. Preferably all components of the curable composition are an admixture with one another, and, preferably, in a substantially uniform admixture.

The photocurable compositions of the invention can be used in the formation of the light transmissive element of an optical device. Examples of such devices are planar optical slab waveguides, channel optical waveguides, ribbed waveguides, optical couplers, routers, combiners and splitters. The photocurable composition of the invention can also be used in the formation of negative working photoresists and other lithographic elements such as printing plates. In a preferred embodiment of the invention, the photocurable composition is used for producing a waveguide comprising a substrate containing a light transmissive element. Such waveguides are formed by applying a film of the photocurable composition of invention to the surface of a suitable substrate. The film may be formed by any method known in the art, such as spin coating, dip coating, slot coating, roller coating and evaporation.

The substrate may be any material on which it is desired to establish a waveguide including semiconductor materials such as silicon, silicon oxide and gallium arsenide. In the event the light transmissive region on the substrate is to be made from a photocurable material which has an index of refraction which is lower than that of the substrate, an intermediate buffer layer possessing an index of refraction which is lower than the substrate must be applied to the substrate before the photocurable composition is added. Otherwise, the light loss in the waveguide will be unacceptable. Suitable buffers are made from semiconductor oxides, lower refractive index polymers or spin on silicon dioxide glass materials.

Once a film of the photocurable composition is applied to the substrate, actinic radiation is directed onto the film in order to delineate the light transmissive region. That is, the position and dimensions of the light transmissive device are determined by the pattern of the actinic radiation upon the surface of the film on the substrate. The photopolymers of the invention are conventionally prepared by exposing the photocurable composition to sufficient actinic radiation. For purposes of this invention, “sufficient actinic radiation” means light energy of the required wavelength, intensity and duration to produce the desired degree of polymerization action in the photocurable composition.

Sources of actinic light, exposure procedures, times, wavelengths and intensities may vary widely depending upon the desired degree of polymerization, the index of refraction of the photopolymer, and other factors known to those of ordinary skill in the art. The selection and optimization of these factors are well known to those skilled in the art.

Preferably that the photochemical excitation be carried out with relatively short wavelengths (or high energy) radiation so that exposure to radiation normally encountered before processing (e.g., room lights) will not prematurely polymerize the polymerizable material. The energy necessary to polymerize the photocurable compositions of the invention generally ranges from about 5 mW/cm² to about 200 mW/cm² with typical exposure times ranging from 0.1 second to about 5 minutes.

After the photocurable composition has been polymerized to form a predetermined pattern on the surface of the substrate, the pattern is then developed to remove the nonimage areas. Any conventional development method can be used such as flushing the non-irradiated composition with a solvent. Suitable solvents include polar solvents, such as alcohols and ketones. The most preferred solvents are acetone, methanol, tetrahydrofuran and ethyl acetate.

While the preferred embodiment of the invention involves photocuring the photocurable composition, as noted above, one skilled in the art will appreciate that many variations of the method within the scope of the claims are possible depending upon the nature of the curable composition. For example, the composition may be heat-cured in an oven or through another heat source such as microwave radiation. Alternately, the composition may be cured using a Lewis Acid catalyst. Depending upon the particular use, the photocurable composition may be partially cured before application to a surface and subsequently fully cured.

The present invention also provides for a polymer comprising one or more fluorinated vinyl ether-epoxide compounds, alone or with other repeating units, wherein the fluorinated vinyl ether-epoxide compounds repeating units have the formula: 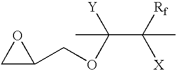
wherein X, Y and R_{f} are the same as described above with respect to Formula I.

In one embodiment, the polymer of the present invention may comprise only vinyl ether repeating units. The polymer may be a homopolymer, comprising first repeating units all derived from the same compound of Formula I, or the polymer may comprise two or more vinyl ether repeating units derived from different compounds of the present invention.

In an alternative embodiment, the polymer of the present invention may include one or more second repeating units derived from other monomers, oligomers, or polymer compounds that have been copolymerized with a vinyl ether compound of the present invention, and which are disclosed above as additional curable compounds that may be included in the curable compositions of the present invention. Such polymers may have a weight average molecular weight ranging from about 600 to about 50,000, preferably from about 600 to about 25,000 and more preferably from about 5,000 to about 10,000. The invention also comprises a method for protecting a surface by applying a composition comprising the fluorinated vinyl ether-epoxide compounds, homopolymers or copolymers of this invention.

The following non-limiting examples serve to illustrate the invention. Those skilled in the art may vary reaction conditions for the examples described herein to produce conversions and product yields which meet their needs.

### EXAMPLE 1

### Preparation of 2-(1,3,3,3-tetrafluoro-propenyloxymethyl)-oxirane

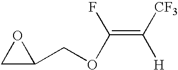

To a reaction flask equipped with a dry ice condenser, gas inlet, and nitrogen feed was charged glycidol (20 g, 0.27 mol), cesium carbonate (43.9 g, 0.135 mol) and acetonitrile (125 mL). 1,1,3,3,3-Pentafluoropropene (35.7 g, 0.27 mol) is added at a rate to maintain the internal reaction temperature at ≦35° C. After 6 h, the reaction was quenched with water, the organic layer, dried over MgSO₄, and distilled. The fraction boiling between 19-25° C./75 mmHg was collected as the product cut. A total of 21 g (42% yield) 2-(1,3,3,3-tetrafluoro-propenyloxymethyl)-oxirane (cis and trans mixture) was isolated. GC/MS (EI) m/e at 186 for M⁺ (M=C₆H₆F₄O₂). NMR spectral data were consistent with the structure.

### EXAMPLE 2

### Preparation of 2-(3,3,3-trifluoro-propenyloxymethyl)-oxirane

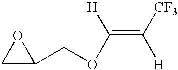

(a) To a stirred mixture of glycidol (20 g, 0.27 mol), acetonitrile (125 mL) and Cs₂CO₃ (52.8 g, 0.16 mol), at 35° C. under nitrogen, was added CF₃CH═CF₂ (HFC-1234) (0.28 mmol) drop-wise via a dry ice condenser. After 6 h, the reaction was quenched with water, the organic layer, dried over MgSO₄, then distilled. The fraction boiling between 19-25° C./55 mmHg was collected as the product cut. A total of 17.92 g (39% yield) 2-(3,3,3-trifluoropropenyloxymethyl)-oxirane (cis/trans mixture) was isolated. GC/MS: m/e at 168 for M⁺ (M=C₆H₇F₃O₂). The NMR spectral data is consistent with the presence of the cis and trans isomers of the product.

(b) The reaction was repeated as above in part (a) except for the fact that olefin CF₃CH═CHCl (HCFC-1233) was substituted in place of CF₃CH═CF₂ to afford 20.96 g (46.2% yield) of 2-(3,3,3-trifluoro-prpenyloxymethyl)-oxirane.

### EXAMPLE 3

### Preparation of 2-Pentafluoropropenyloxymethyl-oxirane

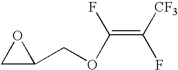

In a similar fashion to that described in Example 1, glycidol and hexafluoropropene was reacted to afford 32.4 g (59% yield) 2-Pentafluoropropenyloxymethyl-oxirane. GC/MS (CI-Mode) m/e at 204 for (M⁺) (M=C₆H₅F₅O₂).

### EXAMPLE 4

In a similar fashion to that described in Example 1, reaction of glycidol with chlorotrifluoroethylene and tetrafluoroethylene gave the corresponding compounds, 2-trifluorovinyloxymethyl-oxirane and 2-(2-chloro-1,2-difluorovinyloxymethyl-oxirane, respectively.

### EXAMPLE 5

### Preparation of 2-(2-Bromo-1,3,3,3-tetrafluoro-propenyloxymethyl)-oxirane

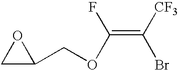

A mixture of glycidol and CF₃CBr═CF₂ was reacted as described in Example 1. Removal of the solvent under reduced pressure at 25° C./20 mmHg yielded 23.6 g of crude 2-(2-bromo-1,3,3,3-tetrafluoro-propenyloxymethyl)-oxirane as a light yellow liquid which was not further purified. The structure was confirmed by GC/MS: m/e at 265 for M⁺ (M=C₅H₅BrF₄O₂).

### EXAMPLE 6

### Preparation of 2-(2-Chloro-3,3,3-trifluoro-propenyloxymethyl)-oxirane

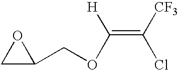

A mixture of glycidol and CF₃CCl═CHCl (HCFC-1223) was reacted as described in Example 1. Removal of the solvent under reduced pressure at 25° C./20 mmHg yielded 27.9 g (51%) of crude 2-(2-Chloro-3,3,3-trifluoropropenyloxymethyl)-oxirane as a light yellow liquid which was not further purified. The structure was confirmed by GC/MS: m/e at 203 for M⁺ (M=C₆H₆ClF₃O₂).

### EXAMPLE 7

### Preparation of 2-(2,3,3,3-Tetrafluoro-propenyloxymethyl)-oxirane

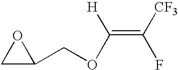

A mixture of glycidol and CF₃CF═CFH was reacted as described in Example 1. Removal of the solvent under reduced pressure at 25° C./20 mmHg yielded 22 g (44%) of crude propenyl oxirane as a light yellow liquid which was not further purified. The structure was confirmed by GC/MS: m/e at 186 for (M⁺) (M=C₆H₆F₄O₂).

### EXAMPLE 8

### Preparation of Perfluoroalkyl-1-enyloxymethyl-oxirane

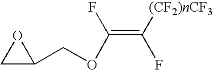

The preparation of this series of oxiranes was accomplished by reacting glycidol and the corresponding perfluoroalkene, CF₃(CF₂)ₙCF═CF₂ (n=1-9) as described in Example 1. Structures were confirmed by GC/MS.

### EXAMPLE 9

### Preparation of 2-(2,3,4,4,4-pentafluoro-1,3-bis-trifluoromethyl-but-1-enyloxymethyl)-oxirane

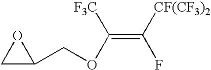

Into a 100 mL round bottom flask equipped with a magnetic stir-bar, condenser, and temperature probe was added glycidol (3.7 g, 50 mmol), acetonitrile (25 mL) and triethylamine (5.5 g, 54 mmol)), at 20° C. under nitrogen. To this stirred reaction mixture was added hexafluoropropene dimer, (CF₃)₂CF—C(F)═C(F)CF₃ (15.0 g, 50 mmol) was drop-wise via an addition funnel such a way that the temperature of the reaction mixture did not rise >30° C. After complete addition of hexafluoropropene dimer, the resultant reaction mixture was stirred for an hour, concentrated on a rotary evaporator under reduced pressure (30 mm Hg) at 30° C. The resultant crude product was successively washed with water (20 mL) and brine (10 mL) and dried (MgSO₄) and filtered to afford 10.1 g crude product. Further purification can be achieved by distillation. GC/MS (CI-mode) m/e at 355 for (M+1)⁺ (M=C₉H₅F₁₁O₂)

### EXAMPLE 10

A series of eight films is prepared by forming a photocurable composition on a substrate surface comprised of 90% by weight of (1) an acrylate formulation comprised of: 80% by weight of Ebecryl 8804; 20% by weight of hexanediol diacrylate (HDODA); 2 parts per hundred (pph) of Irgacure-651 (1-651); and 10% by weight of (2) the fluorinated vinyl ether-epoxide compounds of Examples 1-8. The films are cured by exposing the photocurable compounds under nitrogen using about 200-400 millijoules/cm² UV exposure from a mercury lamp. The films show the good surface properties of polymers prepared from the monomer compounds of the present invention. Films of the polymers are clear with the low surface energies (i.e., surface tension) required by many end-use applications.

### EXAMPLE 11

A series of eight compositions is formed by mixing the following components together until a clear solution is formed:
48.4 g of 3,4-epoxycyclohexylmethyl-3′,4′-epoxycyclohexanecarboxylate (Araldit® CY 179);
18 g of butanediol diglycidyl ether (Araldit® DY 026);
20 g of the fluorinated vinyl ether-epoxide compounds of Examples 1-8.
6 g of dipentaerythritol pentaacrylate (Sartomer® 399);
6 g of bisphenol-A-diglycidyl diacrylate (Novacure® 3700);
0.8 g of 1-hydroxycyclohexylphenyl ketone (Irgacure® 184);
0.8 g of a Cyracure® UVI 6974

Moldings having dimensions of 45.7×0.38×0.5 mm are produced by irradiating the compositions with a He/Cd laser at an irradiation energy of 80 mJ/cm². For a complete full cure the moldings are irradiated for 30 minutes with UV light and then heated for 30 minutes at a temperature of 130° C.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A fluorinated vinyl ether-epoxide compound of the formula 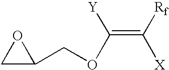
wherein X and Y are independently H, a halogen, or a linear or branched C₁ to C₁₂ fluoroalkyl group; and R_{f} is a linear or branched C₁ to C₁₂ fluoroalkyl group or a halogen.

2. The compound of claim 1 wherein X and Y are independently H, a halogen, or a linear or branched C₁ to C₄ fluoroalkyl group; and R_{f} is a linear or branched C₁ to C₄ fluoroalkyl group.

3. The compound of claim 1 which is 2-(3,3,3-trifluoro-propenyloxymethyl)-oxirane.

4. The compound of claim 1 which is 2-pentafluoropropenyloxymethyl-oxirane.

5. The compound of claim 1 which is 2-trifluorovinyloxymethyl-oxirane.

6. The compound of claim 1 which is 2-(2-chloro-1,2-difluorovinyloxymethyloxirane.

7. The compound of claim 1 which is 2-(2-bromo-1,3,3,3-tetrafluoropropenyloxymethyl)-oxirane.

8. The compound of claim 1 which is 2-(2-chloro-3,3,3-trifluoropropenyloxymethyl)-oxirane.

9. The compound of claim 1 which is 2-(2,3,3,3-tetrafluoro-propenyloxymethyl)-oxirane.

10. The compound of claim 1 which is perfluoroalkyl-1-enyloxymethyl-oxirane.

11. The compound of claim 1 which is 2-(2,3,4,4,4-pentafluoro-1,3-bis-trifluoromethyl-but-1-enyloxymethyl)-oxirane.

12. A process for making a fluorinated vinyl ether-epoxide compound of the formula 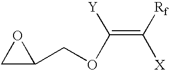
which comprises reacting a glycidol of the formula: 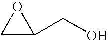
with a fluoroolefin of the formula: 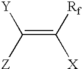
in the presence of a base and a solvent; to thereby produce a fluorinated vinyl ether-epoxide compound; wherein X, Y and Z are independently H, a halogen, or a linear or branched C₁ to C₁₂ fluoroalkyl group, provided at least one of Y and Z are a halogen;
and R_{f} is a linear or branched C₁ to C₁₂ fluoroalkyl group or a halogen.

13. The process of claim 12 wherein X, Y and Z are independently H, a halogen, or a linear or branched C₁ to C₄ fluoroalkyl group, provided at least one of Y and Z are a halogen; and R_{f} is a linear or branched C₁ to C₄ fluoroalkyl group.

14. The process of claim 12 wherein the fluorinated vinyl ether-epoxide compound is selected from the group consisting of 2-(3,3,3-trifluoropropenyloxymethyl)-oxirane; 2-pentafluoropropenyloxymethyl-oxirane; 2-trifluorovinyloxymethyl-oxirane; 2-(2-chloro-1,2-difluorovinyloxymethyl-oxirane; 2-(2-bromo-1,3,3,3-tetrafluoro-propenyloxymethyl)-oxirane; 2-(2-chloro-3,3,3-trifluoro-propenyloxymethyl)-oxirane; 2-(2,3,3,3-tetrafluoropropenyloxymethyl)-oxirane; perfluoroalkyl-1-enyloxymethyl-oxirane; 2-(2,3,4,4,4-pentafluoro-1,3-bis-trifluoromethyl-but-1-enyloxymethyl)-oxirane; and combinations thereof.

15. The process of claim 12 wherein the fluoroolefin is selected from the group consisting of CF₃CH═CF₂, CF₃CH═CFH, CF₃CF═CFH, CF₃CH═CFH, CF₃CBr═CF₂, CF₃CF═CF₂, CF₃CF═CHCl, CF₃CH═CHCl, CF₃CCl═CHCl, (CF₃)₂C═CF₂, (CF₃)₂CF—CF═CF(CF₃), and CF₃(CF₂)ₙCF═CF₂ wherein n=1-9.

16. The process of claim 12 where in the solvent is selected from the group consisting of nitrites, tetrahydrofuran, ethers and combinations thereof.

17. The process of claim 12 where in the base is selected from the group consisting of alkali metal carbonates, alkaline metal carbonates, alkali metal hydroxides, ammonium hydroxide, ammonium carbonate, organic bases, and combinations thereof.

18. The process of claim 12 where in the base is present in a catalytic amount up to one equivalent of the glycidol and the fluoroolefin.

19. The process of claim 12 wherein the reacting is conducted at a temperature of from about −10° C. to about 120° C.

20. The process of claim 12 wherein the resulting fluorinated vinyl ether-epoxide compound is subsequently separated and purified from residual reactants and reaction products.

21. A homopolymer or copolymer comprising units of the formula 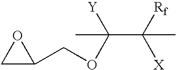
wherein X, Y and Z are independently H, a halogen, or a linear or branched C₁ to C₁₂ fluoroalkyl group, provided at least one of Y and Z are a halogen;
and R_{f} is a linear or branched C₁ to C₁₂ fluoroalkyl group or a halogen.

22. The homopolymer or copolymer of claim 21 having a weight average molecular weight in the range of from about 600 to about 50,000.

23. A composition comprising fluorinated vinyl ether-epoxide compound of the formula 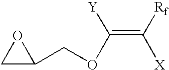
wherein X and Y are independently H, a halogen, or a linear or branched C₁ to C₁₂ fluoroalkyl group; and R_{f} is a linear or branched C₁ to C₁₂ fluoroalkyl group or a halogen; and at least one component selected from the group consisting of solvents, bases, curing agents, polymerization initiators, monomers, oligomers, polymers optionally containing at least one terminal ethylenically unsaturated group and being capable of forming a high molecular weight polymer by free radical initiated, chain propagating addition polymerization; antioxidants, photostabilizers, volume expanders, fillers, dyes, free radical scavengers, contrast enhancers and UV absorbers.

24. A method for protecting a surface comprising applying a surface with a composition comprising the homopolymer or copolymer of claim 21.

25. A method for protecting a surface comprising applying a surface with a composition comprising the homopolymer or copolymer of claim 23.
